(19) United States
(12) Patent Application Publication
(10) Pub. No.: US 2018/0151075 A1
(43) Pub. Date: May 31, 2018

(54) METHOD AND CONTROL UNIT FOR AVOIDING AN ACCIDENT AT A CROSSWALK

(71) Applicant: Scania CV AB, Södertälje (SE)

(72) Inventor: André CLAESSON, Tullinge (SE)

(21) Appl. No.: 15/576,117

(22) PCT Filed: Apr. 15, 2016
(86) PCT No.: PCT/SE2016/050325

§ 371 Date: Nov. 21, 2017

(30) Foreign Application Priority Data
Jun. 4, 2015 (SE) 1550726-2

(51) Int. Cl. G08G 1/16; B60T 7/22; B60T 8/171; B60T 8/172; B60Q 5/00

(52) U.S. Cl. CPC G08G 1/166; B60T 7/22; B60T 8/171; B60T 2250/02; B60Q 5/006; B60T 2201/022; B60T 2210/12; B60T 8/172

(57) ABSTRACT

Method and control unit in a vehicle for avoiding an accident at an unattended crosswalk. The method comprises: detecting an approaching crosswalk; detecting a Vulnerable Road User (VRU) in the vicinity of the crosswalk; determining that the detected VRU is going to walk across the road; determining a distance between the vehicle and the crosswalk; estimating a velocity of the VRU; determining a deceleration capacity of the vehicle, based on deceleration sensitivity of passengers on the vehicle, weight of the vehicle, and/or estimated friction between vehicle tires and the road; and determining a recommended action to be made by the vehicle.

### CROSS-REFERENCE TO RELATED APPLICATION(S)

This application is a national stage application (filed under 35 § U.S.C. 371) of PCT/SE2016/050325, filed Apr. 15, 2016 of the same title, which, in turn claims priority to Swedish Application No. 1550726-2, filed Jun. 4, 2015 of the same title; the contents of each of which are hereby incorporated by reference.

### FIELD OF THE INVENTION

This document discloses a method and a control unit. More particularly, a method and a control unit is described, for avoiding an accident at an unattended crosswalk.

### BACKGROUND OF THE INVENTION

Non-motorized road users, such as e.g. pedestrians and cyclists as well as motor-cyclists and persons with disabilities and/or reduced mobility and orientation are sometimes referred to as Vulnerable Road Users (VRU). This heterogeneous group is disproportionately represented in statistics on injuries and road traffic casualties.

A particularly dangerous scenario is when a VRU, such a pedestrian, is crossing the road at an unattended cross walk in front a vehicle comprising passengers, such as a bus, an ambulance, an Armoured Personnel Carrier (APC) (or other military vehicle), a fire truck etc., where the driver and/or the passengers typically do not use safety belts (in case there even are any safety belts available). The driver of such vehicle is not able to brake the vehicle too sharply, as an on-board accident may occur. On a city bus in rush hour for example, many passengers are often standing. Further, there may be passengers in wheelchair, baby carrier etc., which are in particular sensitive for sudden braking. Even in case the passengers on the bus are seated and belted, busses typically never comprises airbags for passengers, which thus are more exposed for injury in a collision than for example a driver in a car.

On a vehicle such as e.g. garbage trucks, distribution trucks, service vehicles etc., the driver and/or co-driver often do not use safety belt in order to be able to work in a rational manner.

Thus if a driver of such vehicle does not notify a pedestrian on the way of crossing the road at a crosswalk ahead of the vehicle, the vehicle may not be able to stop in time without causing further accidents on-board.

On an ambulance carrying a patient, a sudden panic brake may cause severe injury, additional to the patient's already achieved sufferings and may cause a deterioration of his/her possibilities to recover.

Another problem is that the road may be slippery or icy, which prolongs the braking distance of the vehicle. When driving in such conditions it is even more important to detect a pedestrian intending to cross the road at a distance, in order to have enough braking distance to stop the vehicle, if required.

A particularly hazardous phenomenon is black ice, or clear ice, which refers to a thin coating of glazed ice on a surface, which is virtually transparent, allowing the asphalt road or the surface below to be seen through. Thus neither the driver nor the crossing pedestrian may notice the icy road and the associated prolonged braking distance of the vehicle.

As these described dangerous scenarios, and similar variants of them, may lead to severe accidents as an unprotected VRU is involved, it would be desired to find a solution.

### SUMMARY OF THE INVENTION

It is therefore an object of this invention to solve at least some of the above problems and improve the traffic security.

According to a first aspect of the invention, this objective is achieved by an automated method in a vehicle, for avoiding an accident at an unattended crosswalk. The method comprises detecting that the vehicle is approaching the crosswalk in the driving direction. Further the method comprises detecting a VRU in the vicinity of the crosswalk. In addition the method comprises determining that the detected VRU is going to walk across the road at the crosswalk. Also the method comprises determining distance to the detected crosswalk and current vehicle speed. Furthermore, the method also comprises estimating velocity of the detected VRU for determining if the VRU is going to have time to walk across the crosswalk before the vehicle arrives at the crosswalk. Furthermore, the method also comprises determining deceleration capacity of the vehicle, based on deceleration sensitivity of passengers on the vehicle, cargo on the vehicle, weight of the vehicle, and/or estimated friction between vehicle tires and the road. Additionally, the method also comprises recommending an action to be made by the vehicle, based on inputs from the detection that the vehicle is approaching the crosswalk, the detection of the VRU, the determination that the detected VRU is going to walk across the road at the crosswalk, the determination that the distance to the detected crosswalk and current vehicle speed, the estimated velocity of the detected VRU, and/or the determined deceleration capacity of the vehicle.

According to a second aspect of the invention, this objective is achieved by a control unit in a vehicle. The control unit is configured for avoiding an accident at an unattended crosswalk. The control unit comprises a processor, configured for detecting that the vehicle is approaching a crosswalk in the driving direction. The processor is also configured for detecting a VRU in the vicinity of the crosswalk. Further, the processor is additionally configured for determining that the detected VRU is going to walk across the road at the crosswalk. The processor is also configured for determining distance to the detected crosswalk and current vehicle speed; for estimating velocity of the detected VRU for determining if the VRU is going to have time to walk across the crosswalk before the vehicle arrives at the crosswalk. In addition, the processor is configured for determining deceleration capacity of the vehicle, based on deceleration sensitivity of passengers, cargo on the vehicle, and/or estimated friction between vehicle tires and the road. Furthermore, the processor is additionally configured for recommending an action to be made by the vehicle, based on the estimated velocity of the detected VRU, the determined distance to the detected crosswalk, vehicle speed and the determined deceleration capacity of the vehicle.

Thanks to the described aspects, a VRU entering the road at an unattended crosswalk may be observed by the driver of an approaching vehicle, in time for him/her to stop the vehicle before the crosswalk to let the VRU pass. Thus increased traffic security is achieved.

Other advantages and additional novel features will become apparent from the subsequent detailed description.

### BRIEF DESCRIPTION OF THE DRAWINGS

Embodiments of the invention will now be described in further detail with reference to the accompanying figures, in which:

FIG. 1 illustrates an example of a dangerous traffic scenario;

FIG. 2 illustrates an example of a dangerous traffic scenario and an embodiment of the invention;

FIG. 3 illustrates an example of a dangerous traffic scenario and an embodiment of the invention;

FIG. 4 is a flow chart illustrating an embodiment of the method;

FIG. 5 is an illustration depicting a system according to an embodiment.

### DETAILED DESCRIPTION OF THE INVENTION

Embodiments of the invention described herein are defined as a method and a control unit, which may be put into practice in the embodiments described below. These embodiments may, however, be exemplified and realized in many different forms and are not to be limited to the examples set forth herein; rather, these illustrative examples of embodiments are provided so that this disclosure will be thorough and complete.

Still other objects and features may become apparent from the following detailed description, considered in conjunction with the accompanying drawings. It is to be understood, however, that the drawings are designed solely for purposes of illustration and not as a definition of the limits of the herein disclosed embodiments, for which reference is to be made to the appended claims. Further, the drawings are not necessarily drawn to scale and, unless otherwise indicated, they are merely intended to conceptually illustrate the structures and procedures described herein.

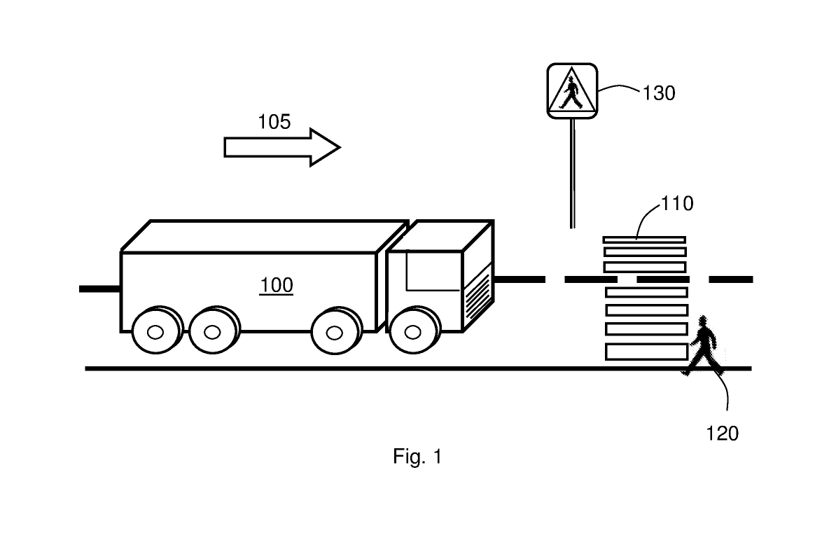

FIG. 1 illustrates a scenario with a vehicle 100 driving in a driving direction 105, approaching an unattended crosswalk 110. A VRU 120 such as e.g. a pedestrian is starting to cross the road in front of the vehicle 100 at the crosswalk 110. The crosswalk 110 is marked with a traffic sign 130.

The vehicle 100 may comprise e.g. a truck, a bus or a car, or any similar vehicle or other means of conveyance. The vehicle 100 may comprise e.g. a passenger carrying vehicle such as a bus.

The vehicle 100 may be driver controlled or driverless autonomously controlled vehicles in different embodiments. However, for enhanced clarity, the vehicle 100 is subsequently described as having a driver.

According to some embodiments, VRUs 120 approaching a road crosswalk are detected. Thereby, the driver of the vehicle 100 may be notified and a retardation may be initiated. When the vehicle 100 is a bus, the retardation down to stop may be handled in a safe way with focus on passenger safety/comfort, which is important for avoiding on-board accidents. This may be in particularly important when there are standing passengers on-board the vehicle 100.

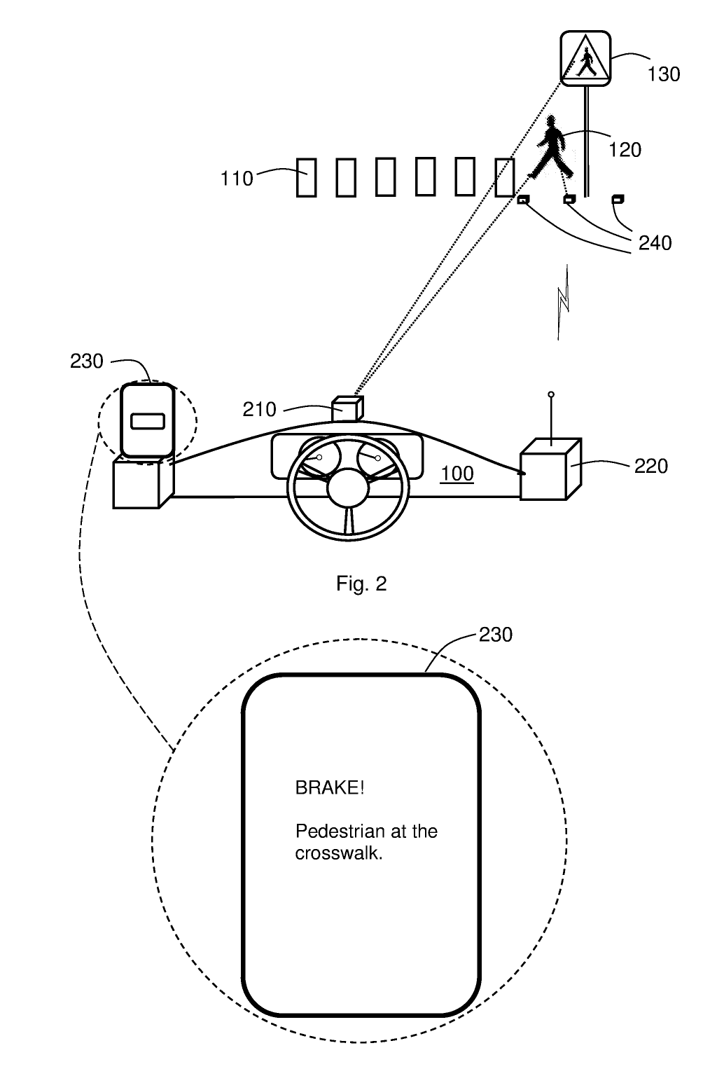

FIG. 2 illustrates an example of how the previously scenario in FIG. 1 may be perceived by the driver of the vehicle 100.

The vehicle 100 is approaching an unattended crosswalk 110 where a VRU 120 is starting to cross the road. The crosswalk 110 is indicated with a traffic sign 130.

The vehicle 100 may comprise a sensor 210, which may be configured for detecting the VRU 120 at the crosswalk 110.

The sensor 210 may comprise a forward-facing camera in the driver area of the vehicle 100, for detecting the crosswalk 110, e.g. by detecting the corresponding traffic sign 130, and also detecting any present or approaching VRU 120.

Besides comprising a camera, the sensor 210 in other embodiments may comprise e.g. a stereo camera, a film camera, or similar device based on radar, infra-red light or micro waves.

In some embodiments, the sensor 210 may comprise, or cooperate with another sensor based on laser, radar or microwaves, for determining the distance to the crosswalk 110 and/or the VRU 120. This information may be utilized for determining if the detected VRU 120 will have time to cross the road before the vehicle 100 arrives, together with information concerning speed of the vehicle 100 and/or appreciated velocity of the VRU 120.

The vehicle 100 may in some embodiments comprise a wireless receiver 220 and a display 230. The wireless receiver 220 may be configured for receiving wireless signals from one or more detectors 240, situated in the vicinity of the crosswalk 110.

The wireless signal may be e.g. a Vehicle-to-Vehicle (V2V) signal, or any other wireless signal based on, or at least inspired by wireless communication technology such as Wi-Fi, Wireless Local Area Network (WLAN), Ultra Mobile Broadband (UMB), Bluetooth (BT), or infrared transmission to name but a few possible examples of wireless communications.

When the detector 240 detects a VRU 120 at the crosswalk 110 a wireless signal is emitted. When receiving the wireless signal at the wireless receiver 220 in the vehicle 100, a warning may be displayed for the driver of the vehicle 100, e.g. by a text message on a display 230 in some embodiments.

Thereby, a function is achieved to detect VRUs 120, i.e. pedestrians, close to the crosswalk 110 and evaluate if the detected VRU 120 intends to cross the road. If this is the case, the driver of the vehicle 100, if any, is informed.

When the vehicle 100 is approaching the road crosswalk 110, this is detected by the vehicle 100, e.g. by the sensor 210 in combination with image interpreting logic, by using Global Positioning System (GPS) data, or by receiving wireless signals from a wireless emitter at the crosswalk 110.

Then, an evaluation is made, for evaluating if the VRU 120 is about to cross the road at the crosswalk. Is there any VRUs 120 close to the crosswalk 110 and do they move against the road?

Input to the vehicle 100 from the surroundings may come from e.g.: on-board mono/stereo cameras; on-board radar; on-board laser scanner; detectors 240 located at the crosswalk 110 may give the vehicle 100 information via wireless signals; or a combination of the above mentioned means.

With this information together with the vehicle distance to the crosswalk 110, vehicle speed etc. it is possible to evaluate whether the vehicle 100 is to slow down/brake to give the VRU 120 priority or not. It might be safe to continue driving the vehicle 100 at current speed.

The conclusion of this estimation may be displayed to the driver, if any, via e.g. a display 230 on the dashboard of the vehicle 100; on a head up display of the vehicle 100; on intelligent glasses; on intelligent lenses; by external projection on the road in front of the vehicle 100, by auditive messages; by warning sounds; by tactile signals and/or a combination thereof, if the vehicle 100 is to slow down/stop. In some embodiments, when the driver is not following the recommended action, or if the vehicle 100 is autonomous, the speed may be slowed down and the vehicle 100 may be prepared to stop. If the vehicle 100 is a city bus with standing passengers extra attention must be taken to comfort/safety during braking, input about the passenger distribution on-board the bus comes from known systems/technique.

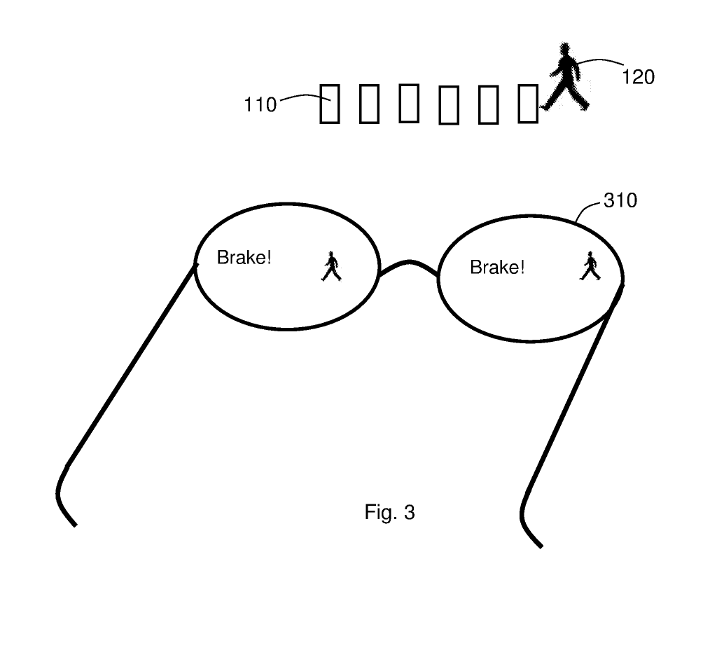

FIG. 3 illustrates an example of how the previously scenario in FIG. 1 and/or FIG. 2 may be perceived by the driver of the vehicle 100, when wearing a pair of intelligent glasses 310.

As described in the above given examples, the vehicle 100 is approaching an unattended crosswalk 110. A VRU 120 walking on, or approaching the crosswalk 110 is detected and a computation is performed for estimating if the vehicle 100 has to brake or not for allowing the VRU 120 to pass. When it is estimated that the driver has to brake the vehicle 100, an instruction may be visualized in the intelligent glasses 310.

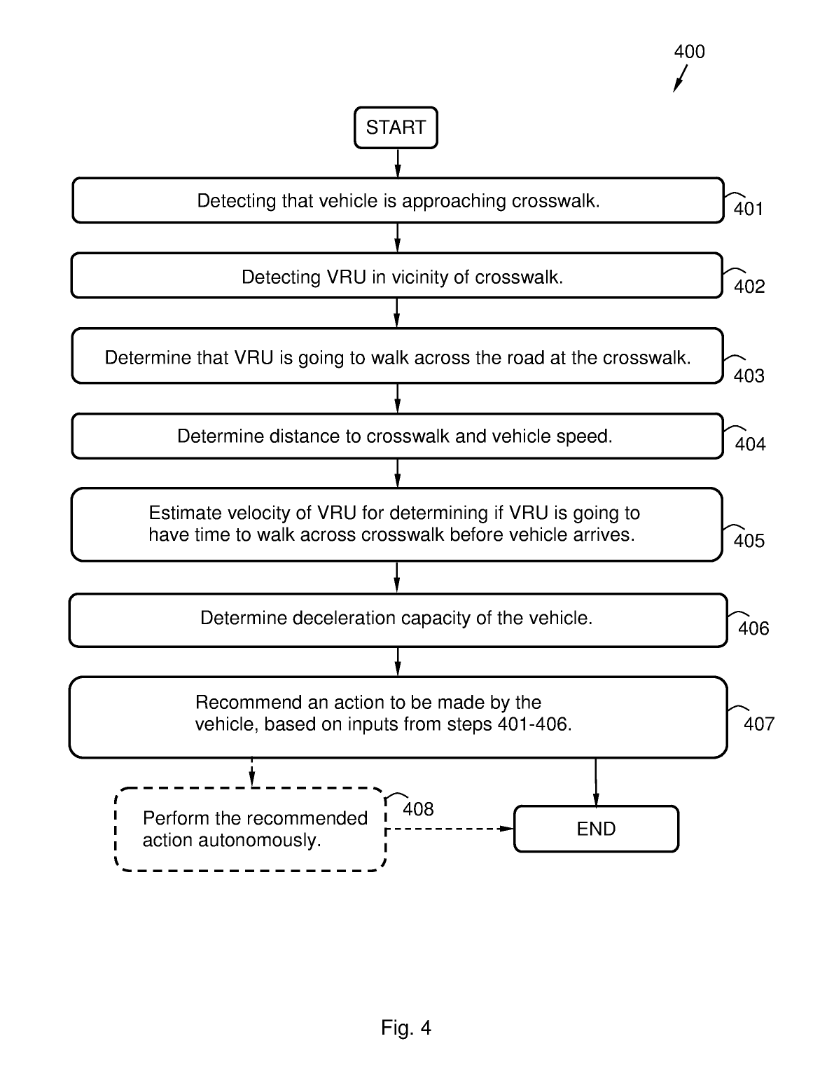

FIG. 4 illustrates an example of an automated method 400 according to an embodiment. The flow chart in FIG. 4 shows the method 400 for use in a vehicle 100 for avoiding an accident at an unattended crosswalk 110.

The vehicle 100 may be any arbitrary kind of means for conveyance. However, in some particular embodiments, the vehicle 100 may be a vehicle comprising passengers, such as a bus, an ambulance, an Armoured Personnel Carrier (APC) (or other military vehicle), a fire truck etc.

In order to correctly be able to avoid accidents at the unattended crosswalk 110, the method 400 may comprise a number of steps 401-408. However, some of these steps 401-408 may be performed solely in some alternative embodiments, like e.g. step 408. Further, the described steps 401-408 may be performed in a somewhat different chronological order than the numbering suggests. The method 400 may comprise the subsequent steps:

Step 401 comprises detecting that the vehicle 100 is approaching a crosswalk 110 in the driving direction 105.

The detection that the vehicle 100 is approaching a crosswalk 110 in the driving direction 105 may be made based on a GPS positioning and a comparison with stored map data in some embodiments.

In other embodiments, a crosswalk sign 130 may be detected by a sensor 210 in the vehicle 100, and by image recognizing logic in the control unit 200.

In yet other embodiments, wireless signals may be emitted from a structure 130 associated with the crosswalk 110, such as a traffic sign. The wireless signals may be received by a receiver 220 in the vehicle 100.

In some other embodiments, the crosswalk 110 may be detected by image recognition of crosswalk markings on the road, made by the sensor 210, and by image recognizing logic in the control unit 200.

Step 402 comprises detecting a VRU 120 in the vicinity of the crosswalk 110.

The detection of the VRU 120 may be made by the sensor 210 in some embodiments.

The sensor 210, which is positioned on the vehicle 100 and directed in the driving direction 105 may in some embodiments comprise e.g. a camera, a stereo camera, an infrared camera and/or a video camera. Presence of a VRU 120 in the vicinity of the crosswalk 110 may be detected through image analysis. According to some embodiments, the sensor 210 may be sensitive for emitted infrared light, e.g. from a pedestrian or animal at the crosswalk 110.

However, in some embodiments, the VRU 120 may be detected by a detector 240 situated in the vicinity of the crosswalk 110. Such detector 240 may be configured for detecting the VRU 120 at the crosswalk 110 and emit a wireless signal, which may be received by a receiver 220 in the vehicle 100.

The detector 240 may comprise e.g. a motion detector and/or be based on a Passive Infrared (PIR) sensor sensitive to a person's skin temperature through emitted black body radiation at mid-infrared wavelengths, in contrast to background objects at room temperature in some embodiments. In other embodiments, the detector 240 may detect VRUs 120 by emitting a continuous wave of microwave radiation and detect motion through the principle of Doppler radar, or by emitting an ultrasonic wave an detecting and analysing the reflections; alternatively by a tomographic motion detection system based on detection of radio wave disturbances.

The detector 240 may however in some embodiments comprise a camera, a stereo camera, an infrared camera or a video camera and presence of a VRU 120 in the vicinity of the crosswalk 110 may be detected through image analysis.

The detection of the VRU 120 in the vicinity of the crosswalk 110 may be made based on information captured by a sensor 210 in the vehicle 100, or information received via a wireless interface from one or more detectors 240 located at the crosswalk 110 in different embodiments.

The mentioned wireless signal may be based on, or at least inspired by wireless communication technology such as Wi-Fi, Wireless Local Area Network (WLAN), Ultra Mobile Broadband (UMB), Bluetooth (BT), or infrared transmission to name but a few possible examples of wireless communications.

Such wireless signals may be received by the wireless receiver 220 in the vehicle, which may comprise an infrastructure information communication device, a radio receiver or similar device configured for receiving wireless signals emitted by the detector 240.

Step 403 comprises determining that the detected 402 VRU 120 is going to walk across the road at the crosswalk 110.

The intention of the detected 402 VRU 120 to walk across the crosswalk 110 may be determined based on an estimation of the velocity of the VRU 120.

The determination of that the detected 402 VRU 120 is going to walk across the road at the crosswalk 110 may be made based on information captured by a sensor 210 in the vehicle 100, or information received via a wireless interface from one or more detectors 220 located at the crosswalk 110 in different embodiments.

It may in some embodiments be determined that the detected 402 VRU 120 is going to walk across the road at the crosswalk 110 when the VRU 120 is detected 402 in the vicinity of the crosswalk 110 and is moving towards the crosswalk 110.

Step 404 comprises determining distance to the detected 401 crosswalk 110 and current vehicle speed.

The sensor 210 may in some embodiments be configured to determine distance to the detected VRU 120. Thus the sensor 210 may comprise, or be connected to a rangefinder comprising an ultrasonic ranging module, a laser rangefinder, a radar distance measurement device or similar.

However, in some embodiments, the distance to the VRU 120 may be estimated implicitly, i.e. in embodiments when the detection 401 that the vehicle 100 is approaching a crosswalk 110 in the driving direction 105 has been made based on a GPS positioning and a comparison with stored map data.

The vehicle speed may be retrieved from the velocity measurement made in the vehicle, or alternatively by determining positions by GPS at time intervals and thereby computing an estimation of the vehicle speed.

Step 405 comprises estimating velocity of the detected 402 VRU 120 for determining if the VRU 120 is going to have time to walk across the crosswalk 110, or the lane, before the vehicle 100 arrives at the crosswalk 110, when the vehicle 100 continue driving at the current speed.

An estimation of the VRU walking velocity may be estimated by making iterated detections of the VRU 120 at a known time interval and compute the required velocity for making the detected position changes at the known time interval, in some embodiments.

However, in some embodiments, the VRU walking velocity may be estimated based on e.g. the size of the VRU 120, i.e. by assuming an approximate walking velocity.

Step 406 comprises determining deceleration capacity of the vehicle 100, based on deceleration sensitivity of passengers on the vehicle 100, cargo on the vehicle 100, weight of the vehicle 100, and/or estimated friction between vehicle tires and the road.

In some embodiments, the required stopping distance for the vehicle 100 may be estimated, if braking the vehicle at the determined deceleration capacity of the vehicle 100.

The deceleration sensitivity of passengers may be evaluated based on whether the passengers are belted or unbelted, standing or sitting, adults or children, disabled or not. Thus the deceleration capacity of the vehicle 100 may be determined such that no accident among the passengers, if any, at the vehicle 100 is occurring, or at least no serious accidents.

The deceleration capacity may further in some embodiments be limited by the type of vehicle, such as e.g. an ambulance with a patient on-board.

Further, in some embodiments, when the vehicle 100 comprises a bus or similar vehicle for transportation of passengers standing passengers may be detected by a sensor such as a camera or similar device directed towards the passenger area of the vehicle 100. Further, e.g. the presence of children, elder people, disabled passengers, wheelchairs etc. may be detected.

Thereby, a vehicle 100 having standing passengers may be assumed to have a lower deceleration capacity than a vehicle 100 having only seated passengers, which in turn may be assumed to have a lower deceleration capacity than a vehicle 100 having only belted passengers.

In some embodiments when the vehicle 100 is a city bus, the amount of passengers and/or existence of standing passengers may be estimated based on the time of the day and day of the week.

Further, the weight of the vehicle 100 may be estimated. In case the vehicle 100 comprises a bus, the number of passengers may be counted or estimated and an approximate average weight may be added to the known weight of the empty bus.

In case the vehicle 100 comprises a truck, the loaded truck may have a considerably longer stopping distance than an empty truck.

The estimation of friction between vehicle tires and the road, according to some embodiments, may be made based on determining the type of tire on the vehicle 100, estimating abrasion of the tires and measuring ambient temperature for determining whether it is freezing degrees or not in some embodiments.

Detection of freezing degrees may generate a deceleration capacity of the vehicle 100 than when the temperature is above zero.

Step 407 comprises recommending an action to be made by the vehicle 100, based on inputs from steps 401-406. Thus the recommendation may be based on any, some or all of: the detected 401 approaching crosswalk 110; the detected 402 VRU at the crosswalk 110; the determination 403 that the VRU is going to walk across the road at the crosswalk 110; the determined 404 distance to the crosswalk and current vehicle speed; the estimated 405 velocity of the VRU; and/or the determined deceleration capacity of the vehicle 100.

The recommended action may be selected from a set of actions comprising: maintaining current speed; slow down the vehicle 100; brake the vehicle 100 and stop; slow down the speed, at the determined 406 deceleration capacity of the vehicle 100 and horn.

The recommended action may comprise maintaining current speed of the vehicle 100 when no VRU 120 is detected 402 in the vicinity of the crosswalk 110; or when the detected 402 VRU 120 is not determined 403 to walk across the road at the crosswalk 110; or when the estimated 405 velocity of the detected 402 VRU 120 indicates that he/she will have time to walk across the crosswalk 110 before the vehicle 100 arrives at the crosswalk 110.

Alternatively, the recommended action may comprise slowing down the vehicle 100 (at a deceleration lower than the determined 406 deceleration capacity of the vehicle 100) to a reduced speed, when the estimated 405 velocity of the detected 402 VRU 120 indicates that he/she will have time to walk across the crosswalk 110 before the vehicle 100 arrives at the crosswalk 110, at the reduced speed.

The recommended action may further comprise braking the vehicle 100 and stop before the crosswalk 110, at the determined 306 deceleration capacity of the vehicle 100, when the estimated 405 velocity of the detected 402 VRU 120 indicates that he/she will not have time to walk across the crosswalk 110 before the vehicle 100 arrives at the crosswalk 110, and the determined 406 deceleration capacity of the vehicle 100 exceeds the deceleration required to stop the vehicle 100 at the determined 404 distance to the detected 401 crosswalk 110 from the current vehicle speed.

Further, the recommended action may comprise slowing down at the determined 406 deceleration capacity of the vehicle 100 and horn when the estimated 405 velocity of the detected 402 VRU 120 indicates that he/she will not have time to walk across the crosswalk 110 before the vehicle 100 arrives at the crosswalk 110, and the determined 406 deceleration capacity of the vehicle 100 is less than the deceleration required to stop the vehicle 100 at the determined 404 distance to the detected 401 crosswalk 110 from the current vehicle speed.

The last alternative is perhaps to be regarded as an emergency action in case the risk of an accident is imminent. By braking the vehicle 100 as much as possible without exceeding the determined 406 deceleration capacity of the vehicle 100, an on-board accident may be avoided. Further, by activating the horn, the VRU 120 is made aware of the approaching vehicle 100 and may speed up the walking for avoiding an upcoming accident.

In some embodiments, the driver may be encouraged to, besides activating the horn, also ignite the headlights of the vehicle 100 and/or flashing with the headlights.

The recommended action to be made by the driver of the vehicle 100 may be presented on a display 230 in the vehicle 100 in some embodiments. Alternatively, the recommended action may be displayed on a head up display, on a transparent display integrated in the windshield of the vehicle 100, on a transparent display integrated in a pair of glasses 310 carried by the driver, on a transparent display integrated in a pair of contact lenses carried by the driver, by a projection made on the road in front of the vehicle 100, by a loudspeaker, and/or by a tactile vibrator having contact with a body part of the driver in different embodiments. Further, the recommended action may be made on a combination of the above mentioned means simultaneously.

Step 408, which may be performed only in some alternative embodiments in case there is no driver present at the vehicle 100, or when the driver does not perform the recommended 407 action, may comprise performing the recommended 407 action autonomously.

The recommended action to be performed may comprise maintaining current speed and continue driving, slow down the vehicle speed, stop the vehicle 100, or slow down the vehicle 100 at the determined 406 deceleration capacity of the vehicle 100, and horn.

Thus in some embodiments, a brake may be initiated and performed autonomously in case the driver does not follow the recommended 407 action. Thereby an accident may be avoided.

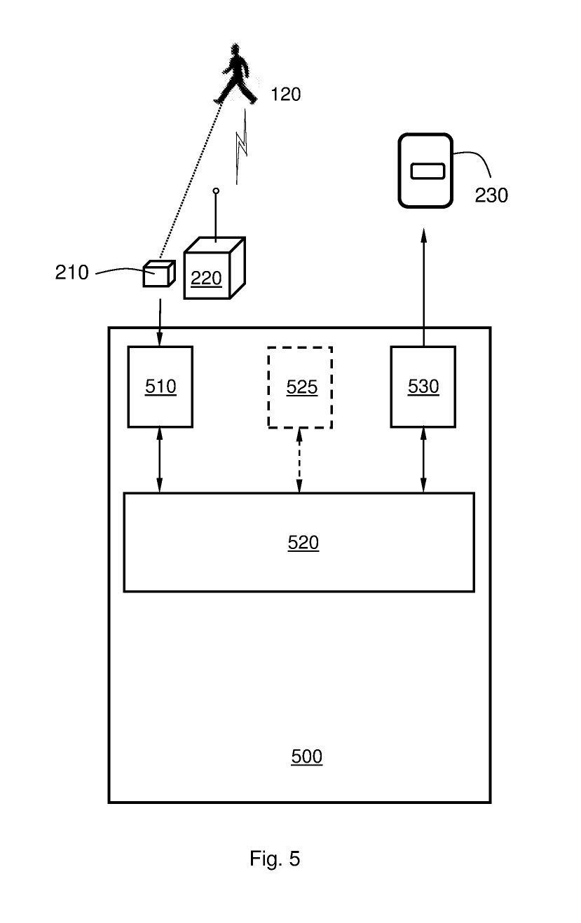

FIG. 5 illustrates an embodiment of a control unit 500 in a vehicle 100. The control unit 500 is configured for avoiding an accident at an unattended crosswalk 110. The control unit 500 may perform at least some of the previously described steps 401-408 according to the automated method 400 described above and illustrated in FIG. 4.

The control unit 500 comprises a processor 520 configured for detecting that the vehicle 100 is approaching a crosswalk 110 in the driving direction 105 of the vehicle 100. Further, the processor 520 is configured for detecting a VRU 120 in the vicinity of the crosswalk 110. In addition, the processor 520 is further configured for determining that the detected VRU 120 is going to walk across the road at the crosswalk 110. The processor 520 is further configured for determining distance to the detected crosswalk 110 and current vehicle speed. Also the processor 520 is configured for estimating velocity of the detected VRU 120 for determining if the VRU 120 is going to have time to walk across the crosswalk 110 before the vehicle 100 arrives at the crosswalk 110. The processor 520 is furthermore configured for determining deceleration capacity of the vehicle 100, based on deceleration sensitivity of passengers, cargo on the vehicle 100, and/or estimated friction between vehicle tires and the road. Additionally, the processor 520 is also configured for recommending an action to be made by the vehicle 100, based on the estimated velocity of the detected VRU 120, the determined distance to the detected crosswalk 110, vehicle speed and the determined deceleration capacity of the vehicle 100.

The recommendation may comprise continue driving at the current vehicle speed, slowing down the vehicle 100, stopping the vehicle 100, or slowing down the vehicle 100 at the determined deceleration capacity of the vehicle 100 and horn, in some embodiments.

In some embodiments, the processor 520 may furthermore be optionally configured for generating control signals for performing the recommended action autonomously, e.g. in case the vehicle 100 does not have any driver, or in case the driver does not follow the recommended action.

Such processor 520 may comprise one or more instances of a processing circuit, i.e. a Central Processing Unit (CPU), a processing unit, a processing circuit, an Application Specific Integrated Circuit (ASIC), a microprocessor, or other processing logic that may interpret and execute instructions. The herein utilized expression “processor” may thus represent a processing circuitry comprising a plurality of processing circuits, such as, e.g., any, some or all of the ones enumerated above.

The control unit 500 may further comprise a receiving circuit 510 configured for receiving a signal from a sensor 210 and/or a receiver 220 in the vehicle 100, indicating presence of the VRU 120 in the vicinity of the cross walk.

Furthermore, the control unit 500 may comprise a memory 525 in some embodiments. The optional memory 525 may comprise a physical device utilized to store data or programs, i.e., sequences of instructions, on a temporary or permanent basis. According to some embodiments, the memory 525 may comprise integrated circuits comprising silicon-based transistors. The memory 525 may comprise e.g. a memory card, a flash memory, a USB memory, a hard disc, or another similar volatile or non-volatile storage unit for storing data such as e.g. ROM (Read-Only Memory), PROM (Programmable Read-Only Memory), EPROM (Erasable PROM), EEPROM (Electrically Erasable PROM), etc. in different embodiments.

Further, the control unit 500 may comprise a signal transmitter 530. The signal transmitter 530 may be configured for transmitting a control signal to be received by a display device 230, 310; or by a brake and/or horn in some embodiments.

The previously described steps 401-408 to be performed in the control unit 500 may be implemented through the one or more processors 520 within the control unit 500, together with computer program product for performing at least some of the functions of the steps 401-408. Thus a computer program product, comprising instructions for performing the steps 401-408 in the control unit 500 may perform the method 400 comprising at least some of the steps 401-408 for avoiding an accident at an unattended crosswalk 110, when the computer program is loaded into the one or more processors 520 of the control unit 500.

Further, some embodiments may comprise a vehicle 100, comprising the control unit 500, configured for warning a VRU 120 situated in a vicinity of a cross walk 110, according to at least some of the steps 401-408.

The computer program product mentioned above may be provided for instance in the form of a data carrier carrying computer program code for performing at least some of the step 401-408 according to some embodiments when being loaded into the one or more processors 520 of the control unit 500. The data carrier may be, e.g., a hard disk, a CD ROM disc, a memory stick, an optical storage device, a magnetic storage device or any other appropriate medium such as a disk or tape that may hold machine readable data in a non-transitory manner. The computer program product may furthermore be provided as computer program code on a server and downloaded to the control unit 500 remotely, e.g., over an Internet or an intranet connection.

The terminology used in the description of the embodiments as illustrated in the accompanying drawings is not intended to be limiting of the described method 400; the control unit 500; the computer program and/or the vehicle 102. Various changes, substitutions and/or alterations may be made, without departing from invention embodiments as defined by the appended claims.

As used herein, the term “and/or” comprises any and all combinations of one or more of the associated listed items. The term “or” as used herein, is to be interpreted as a mathematical OR, i.e., as an inclusive disjunction; not as a mathematical exclusive OR (XOR), unless expressly stated otherwise. In addition, the singular forms “a”, “an” and “the” are to be interpreted as “at least one”, thus also possibly comprising a plurality of entities of the same kind, unless expressly stated otherwise. It will be further understood that the terms “includes”, “comprises”, “including” and/or “comprising”, specifies the presence of stated features, actions, integers, steps, operations, elements, and/or components, but do not preclude the presence or addition of one or more other features, actions, integers, steps, operations, elements, components, and/or groups thereof. A single unit such as e.g. a processor may fulfil the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms such as via Internet or other wired or wireless communication system.

1. An automated method in a vehicle, for avoiding an accident at an unattended crosswalk, said method comprising:
detecting that the vehicle is approaching a crosswalk in a driving direction;
detecting a Vulnerable Road User (VRU) in the vicinity of the crosswalk;
determining that the detected VRU is going to walk across the road at the crosswalk;
determining a distance between the vehicle and the detected crosswalk and a current vehicle speed;
estimating a velocity of the detected VRU for determining if the VRU is going to have time to walk across the crosswalk before the vehicle arrives at the crosswalk;
determining a deceleration capacity of the vehicle, based on a deceleration sensitivity of passengers on the vehicle, cargo on the vehicle, a weight of the vehicle, and/or an estimated friction between vehicle tires and the road; and
determining a recommended action to be made by the vehicle wherein the recommended action is selected from a set of actions comprising: maintaining a current speed; slow down a speed of the vehicle; brake the vehicle and stop; or slow down the speed at the determined deceleration capacity of the vehicle and activate a horn.

2. (canceled)

3. The method according to claim 1, wherein the recommended action comprises:
Maintaining a current speed of the vehicle when no VRU is detected in the vicinity of the crosswalk; or when the detected VRU is not determined to walk across the road at the crosswalk; or when the estimated velocity of the detected VRU indicates that he/she will have time to walk across the crosswalk before the vehicle arrives at the crosswalk;
slow down the vehicle to a reduced speed, when the estimated velocity of the detected VRU indicates that he/she will have time to walk across the crosswalk before the vehicle arrives at the crosswalk, at the reduced speed;
brake the vehicle and stop before the crosswalk, at the determined deceleration capacity of the vehicle, when the estimated velocity of the detected VRU indicates that he/she will not have time to walk across the crosswalk before the vehicle arrives at the crosswalk, and the determined deceleration capacity of the vehicle exceeds the deceleration required to stop the vehicle at the determined distance to the detected crosswalk from the current vehicle speed; or
slow down at the determined deceleration capacity of the vehicle and activate a horn when the estimated velocity of the detected VRU indicates that he/she will not have time to walk across the crosswalk before the vehicle arrives at the crosswalk, and the determined deceleration capacity of the vehicle is less than the deceleration required to stop the vehicle at the determined distance to the detected crosswalk from the current vehicle speed.

4. The method according to claim 1, wherein the deceleration sensitivity of passengers is evaluated based on whether the passengers are using a seat belt or not, standing or sitting, adults or children, disabled or not.

5. The method according to claim 1, further comprising, in case there is no driver present in the vehicle, or when the driver does not perform the recommended action within a time period:
performing the recommended action autonomously.

6. The method according to claim 1, wherein the estimation of friction between vehicle tires and the road is based on determining the type of tire on the vehicle, estimating an abrasion of the tire and measuring an ambient temperature for determining whether it is freezing degrees or not.

7. The method according to claim 1, wherein the detection that the vehicle is approaching a crosswalk in the driving direction is made based on: a GPS positioning and a comparison with stored map data; detection of a crosswalk sign from a sensor; reception of a wireless signal emitted from a structure associated with the crosswalk; or an image recognition of crosswalk markings on the road.

8. The method according to claim 1, wherein the detection of the VRU in the vicinity of the crosswalk, and the determination of that the detected VRU is going to walk across the road at the crosswalk are made based on: information captured by a sensor in the vehicle; or information received via a wireless interface from one or more detectors located at the crosswalk.

9. The method according to claim 1, wherein it is determined that the detected VRU is going to walk across the road at the crosswalk when the VRU is detected in the vicinity of the crosswalk and is moving towards the crosswalk.

10. The method according to claim 1, wherein, in case a driver is present in the vehicle, the recommended action is presented: on a display in the vehicle; on a head up display; on a transparent display integrated in the windshield of the vehicle; on a transparent display integrated in a pair of glasses carried by the driver; on a transparent display integrated in a pair of contact lenses carried by the driver; by a projection made on the road in front of the vehicle; by a speaker; and/or by a tactile vibrator having contact with a body part of the driver.

11. A control unit in a vehicle, configured for avoiding an accident at an unattended crosswalk, said method comprising:
a processor configured for:
detecting that the vehicle is approaching a crosswalk in a the driving direction;
detecting a VRU in the vicinity of the crosswalk;
determining that the detected VRU is going to walk across the road at the crosswalk;
determining a distance between the vehicle and to the detected crosswalk and a current vehicle speed;
estimating a velocity of the detected VRU for determining if the VRU is going to have time to walk across the crosswalk before the vehicle arrives at the crosswalk;
determining a deceleration capacity of the vehicle, based on a deceleration sensitivity of passengers, cargo on the vehicle a weight of the vehicle, and/or an estimated friction between vehicle tires and the road; and
determining a recommended action to be made by the vehicle, based on the estimated velocity of the detected VRU, the determined distance to the detected crosswalk, vehicle speed and the determined deceleration capacity of the vehicle, wherein the recommended action is selected from a set of actions comprising: maintaining a current speed; slow down a speed of the vehicle; brake the vehicle and stop; or slow down a speed of the vehicle, at the determined deceleration capacity of the vehicle and activate a horn.

12. A computer program product comprising computer program code stored on a non-transitory computer-readable medium readable by a computer, said computer program product for avoiding an accident at an unattended crosswalk, said computer program code comprising computer instructions to cause one or more computer processors to perform the following operations:
detecting that the vehicle is approaching a crosswalk in a driving direction;
detecting a VRU in the vicinity of the crosswalk;
determining that the detected VRU is going to walk across the road at the crosswalk:
determining a distance between the vehicle and to the detected crosswalk and a current vehicle speed;
estimating a velocity of the detected VRU for determining if the VRU is going to have time to walk across the crosswalk before the vehicle arrives at the crosswalk;
determining a deceleration capacity of the vehicle, based on a deceleration sensitivity of passengers, cargo on the vehicle, a weight of the vehicle, and/or an estimated friction between vehicle tires and the road; and
determining a recommended action to be made by the vehicle, based on the estimated velocity of the detected VRU, the determined distance to the detected crosswalk, vehicle speed and the determined deceleration capacity of the vehicle, wherein the recommended action is selected from a set of actions comprising: maintaining a current speed; slow down a speed of the vehicle; brake the vehicle and stop; or slow down a speed of the vehicle, at the determined deceleration capacity of the vehicle and activate a horn.

13. (canceled)

14. The computer program product according to claim 12, wherein the recommended action comprises:
maintaining a current speed of the vehicle when no VRU is detected in the vicinity of the crosswalk; or when the detected VRU is not determined to walk across the road at the crosswalk; or when the estimated velocity of the detected VRU indicates that he/she will have time to walk across the crosswalk before the vehicle arrives at the crosswalk;
slow down the vehicle to a reduced speed, when the estimated velocity of the detected VRU indicates that he/she will have time to walk across the crosswalk before the vehicle arrives at the crosswalk, at the reduced speed;
brake the vehicle and stop before the crosswalk, at the determined deceleration capacity of the vehicle, when the estimated velocity of the detected VRU indicates that he/she will not have time to walk across the crosswalk before the vehicle arrives at the crosswalk, and the determined deceleration capacity of the vehicle exceeds the deceleration required to stop the vehicle at the determined distance to the detected crosswalk from the current vehicle speed; or
slow down at the determined deceleration capacity of the vehicle and activate a horn when the estimated velocity of the detected VRU indicates that he/she will not have time to walk across the crosswalk before the vehicle arrives at the crosswalk, and the determined deceleration capacity of the vehicle is less than the deceleration required to stop the vehicle at the determined distance to the detected crosswalk from the current vehicle speed.

15. The computer program product according to claim 12, wherein the deceleration sensitivity of passengers is evaluated based on whether the passengers are using a seat belt or not, standing or sitting, adults or children, disabled or not.

16. The computer program product according to claim 12, further comprising, in case there is no driver present in the vehicle, or when the driver does not perform the recommended action within a time period:
performing the recommended action autonomously.

17. The computer program product according to claim 12, wherein the estimation of friction between vehicle tires and the road is based on determining the type of tire on the vehicle, estimating an abrasion of the tire and measuring an ambient temperature for determining whether it is freezing degrees or not.

18. The computer program product according to claim 12, wherein the detection that the vehicle is approaching a crosswalk in the driving direction is made based on: a GPS positioning and a comparison with stored map data; detection of a crosswalk sign from a sensor; reception of a wireless signal emitted from a structure associated with the crosswalk; or an image recognition of crosswalk markings on the road.

19. The computer program product according to claim 12, wherein the detection of the VRU in the vicinity of the crosswalk, and the determination of that the detected VRU is going to walk across the road at the crosswalk are made based on: information captured by a sensor in the vehicle; or information received via a wireless interface from one or more detectors located at the crosswalk.

20. The computer program product according to claim 12, wherein it is determined that the detected VRU is going to walk across the road at the crosswalk when the VRU is detected in the vicinity of the crosswalk and is moving towards the crosswalk.

21. The computer program product according to claim 12, wherein, in case a driver is present in the vehicle, the recommended action is presented: on a display in the vehicle; on a head up display; on a transparent display integrated in the windshield of the vehicle; on a transparent display integrated in a pair of glasses carried by the driver; on a transparent display integrated in a pair of contact lenses carried by the driver; by a projection made on the road in front of the vehicle; by a speaker; and/or by a tactile vibrator having contact with a body part of the driver.
